(19) United States
(12) Patent Application Publication
(10) Pub. No.: US 2025/0012120 A1
(43) Pub. Date: Jan. 9, 2025

(54) VEHICLE DOOR LATCH

(71) Applicant: Inteva France, SULLY-SUR-LOIRE (FR)

(72) Inventors: Pascal Philippe, Orleans (FR); Yoshihiko Tametani, Tokyo (JP); Takaya Kuriyama, Tokyo (JP)

(21) Appl. No.: 18/764,771

(22) Filed: Jul. 5, 2024

(30) Foreign Application Priority Data
Jul. 7, 2023 (FR) 2307280

(51) Int. Cl. E05B 81/16; E05B 77/28; E05B 81/06; E05B 81/34; E05B 81/42

(52) U.S. Cl. CPC E05B 81/16; E05B 77/28; E05B 81/06; E05B 81/34; E05B 81/42

(57) ABSTRACT

A vehicle latch, including: only a single motor for driving a worm operably coupled to the single motor, the worm meshingly engages a wheel rotatably mounted to a housing of the latch; during an electric release of the latch the single motor rotates the wheel from a reset position in a first direction, thereafter and to return the wheel to the reset position the single motor rotates the wheel in a second direction, which is opposite to the first direction; and rotation of the of the wheel by the single motor from the reset position in the second direction will position the latch into a Power Child Lock and/or the Double Lock position, thereafter the wheel is rotated back into the reset position by a spring, rotation of the wheel by the single motor from the reset position in the second direction a second time will disengage the latch from the Power Child Lock and/or the Double Lock position, making mechanical opening of the latch operational, thereafter the wheel is rotated back into the reset position by a spring.

### CROSS REFERENCE TO RELATED APPLICATIONS

This application claims the benefit of French provisional application No. 23/07280 filed on Jul. 7, 2023, the contents of which are incorporated herein by reference thereto.

### BACKGROUND

Exemplary embodiments of the present disclosure pertain to the art of vehicle door latches.

Vehicle door latches include multiple components that cooperate with each other in order to provide operation of the vehicle door latch. In some applications, the latches are electrically opened with a motor operably coupled to the latch. In these applications, a second motor is typically required to place the latch in a position so that is can be mechanically operated or opened in the event of a power loss to the latch.

For example and in an electrical release door latch, when mechanical redundant back up is requested, a second motor is needed to manage the disengagement/re-engagement of a mechanical link such as a power child lock or double lock function on the inside mechanical backup or lock/unlock for the outside release backup.

Reducing the number of components in a latch assembly and using them or using them for multiple functions is a difficult task to accomplish.

As such, it is desirable to provide an improved vehicle door latch wherein the latch which can operate as desired while reducing the number of components required for operation of the latch.

### BRIEF DESCRIPTION

Disclosed is a vehicle latch, including: only a single motor for driving a worm operably coupled to the single motor, the worm meshingly engages a wheel rotatably mounted to a housing of the latch; during an electric release of the latch the single motor rotates the wheel from a reset position in a first direction, thereafter and to return the wheel to the reset position the single motor rotates the wheel in a second direction, which is opposite to the first direction; and rotation of the wheel by the single motor from the reset position in the second direction will position the latch into a Power Child Lock and/or the Double Lock position, thereafter the wheel is rotated back into the reset position by a spring, rotation of the of the wheel by the single motor from the reset position in the second direction a second time will disengage the latch from the Power Child Lock and/or the Double Lock position, making mechanical opening of the latch operational, thereafter the wheel is rotated back into the reset position by a spring.

Also disclosed is a method of opening a vehicle latch with only a single motor, including: operably coupling the only a single motor for driving a worm operably coupled to the single motor, the worm meshingly engages a wheel rotatably mounted to a housing of the latch; electrically releasing the latch with the single motor by rotating the wheel from a reset position in a first direction, thereafter returning the wheel to the reset position by rotating the single motor in a second direction, which is opposite to the first direction; and placing the latch into a Power Child Lock and/or the Double Lock position by rotating the wheel by the single motor from the reset position in the second direction, thereafter the wheel is rotated back into the reset position by a spring; and disengaging the latch from the Power Child Lock and/or the Double Lock position, by rotating the wheel by the single motor from the reset position in the second direction a second time, thereby making mechanical opening of the latch operational, thereafter the wheel is rotated back into the reset position by a spring.

### BRIEF DESCRIPTION OF THE DRAWINGS

The following descriptions should not be considered limiting in any way. With reference to the accompanying drawings, like elements are numbered alike:

FIGS. 1 and 2 illustrates portions of a vehicle latch in accordance with an embodiment of the present disclosure;

FIG. 3 is a graphical representation of operational aspects of the vehicle latch in accordance with an embodiment of the present disclosure;

FIGS. 4A-4F illustrate operation of the vehicle latch in accordance with an embodiment of the present disclosure;

FIGS. 5A and 5B are exploded views of components of the vehicle latch in accordance with an embodiment of the present disclosure;

FIGS. 6A and 6B illustrate movement of the lock pin of the vehicle latch within a cam feature of the lock lever;

FIG. 7 illustrates portions of the vehicle latch in a door closed position wherein the latch is operational for electrical release and for mechanical release through double pull or single pull operations;

FIGS. 8-10 illustrate portions of the vehicle latch in a door closed position wherein the latch is not operational for double pull or single pull operations;

FIGS. 11-12 illustrate portions of the vehicle latch in a door closed position wherein the latch is operational for double pull or single pull operations;

FIG. 13A illustrate portions of the vehicle latch wherein the latch is not operational for double pull or single pull operations;

FIG. 13B illustrate portions of the vehicle latch wherein the latch is operational for double pull or single pull operations;

FIGS. 14A-14C illustrate portions of the vehicle latch in a door closed position wherein the latch is operational for double pull or single pull operations;

FIGS. 15A-15C illustrate portions of the vehicle latch in a door closed position during a first pull on a handle operatively coupled to the vehicle latch when the latch is operational for mechanical release;

FIGS. 16A-16C illustrate portions of the vehicle latch in a door closed position after a first pull on a handle operatively coupled to the vehicle latch when the latch is operational for mechanical release;

FIGS. 17A-17C illustrate portions of the vehicle latch in a door closed position after a first pull on a handle operatively coupled to the vehicle latch when the latch is operational for mechanical release; and

FIGS. 18A-18C illustrate portions of the vehicle latch in a door closed position during a second pull on a handle operatively coupled to the vehicle latch when the latch is operational for mechanical release.

### DETAILED DESCRIPTION

A detailed description of one or more embodiments of the disclosed apparatus and method are presented herein by way of exemplification and not limitation with reference to the Figures.

The present disclosure is directed to a vehicle door latch or latch that provides electrical release of the vehicle door latch and re-engagement of a mechanical back up release from inside the vehicle with only one motor instead two motors. This is particularly useful for rear door equipped with child lock and/or all doors equipped with a super lock or double lock versions.

In accordance with an embodiment of the present disclosure, the latch has at least three predefined positions (closed/primary position, partially open/secondary position or fully open).

In accordance with one embodiment of the present disclosure and when a claw of the latch is in an open position a temporary mechanical stop is provided for a release actuator when the release actuator is in a floating position that corresponds to a rest or home position of the release actuator.

From this “floating” position and when the latch is in a closed position, a release motor of the release actuator rotates in one direction to open the latch or in an opposite direction to disengage or to re-engage the mechanical back up. When the door is opened via electric release, powering the motor again in an opposite direction, rearms the release actuator to either open again electrically the latch or disengage or re-engage the mechanical back up. When a claw of the latch is in an open position the latch will prevent the release actuator to reach a position corresponding to disengagement or to re-engagement of the mechanical backup.

The present disclosure is directed to using one motor for the power release and the disengagement/re-engagement of the mechanical backup release.

In addition, the present disclosure uses the direction of rotation of the motor for the power release and the second of rotation of the motor to realize the disengagement or the re-engagement of the mechanical release link thru a specific cam design and springs.

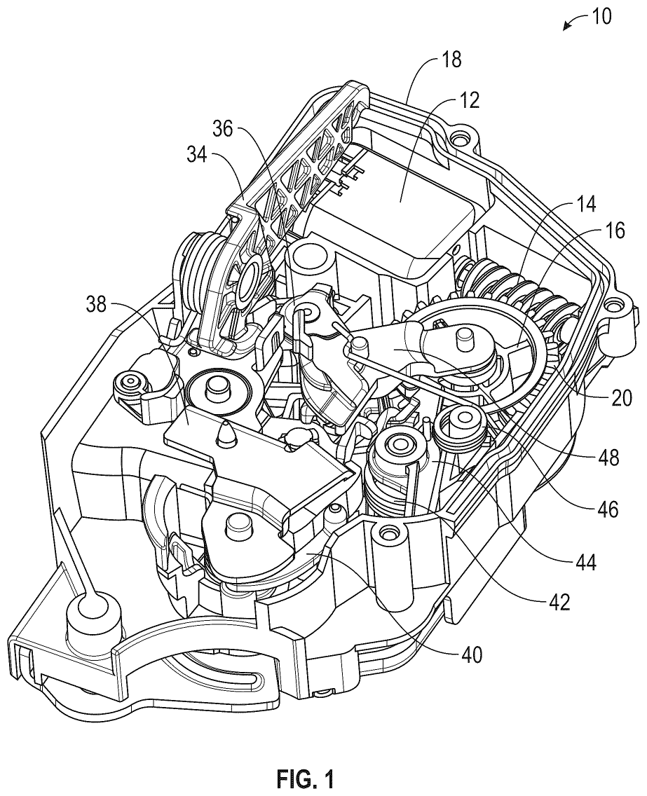

Referring now to FIGS. 1-19C, various aspects of the present disclosure will be discussed.

FIG. 1 illustrates portions of a vehicle door latch or latch 10 in accordance with an embodiment of the present disclosure. The vehicle door latch or latch 10 has only a single motor 12 for driving a worm 14 operably coupled to the motor 12. In other words, there is only one motor in the latch 10. The worm 14 meshingly engages a wheel 16 rotatably mounted to a housing 18 of the latch 10. The worm 14 meshingly engages a plurality of teeth 20 located about a periphery of the wheel 16. The wheel 16 also has a cam portion 22 located on one side of the wheel 16 and a driving feature 24 located on an opposite side of the wheel 16.

The cam portion 22 is configured for engaging a release lever 26 while the driving feature 24 is configured to engage a block lever 28. Both the release lever 26 and the block lever 28 are rotatably mounted to the latch 10. The release lever 26 is operably coupled a pawl 30 such that movement of the release lever 26 by the cam portion 22 of the wheel 16 will cause movement of the pawl 30. The pawl 30 is configured to engage a claw 32 of the latch 10 in order to maintain the claw 32 in a closed or secondary position or primary position. Movement of the pawl 30 from an engaged position to a disengaged position will allow the claw 32 to pivot or rotate into an open position as is know in the related arts.

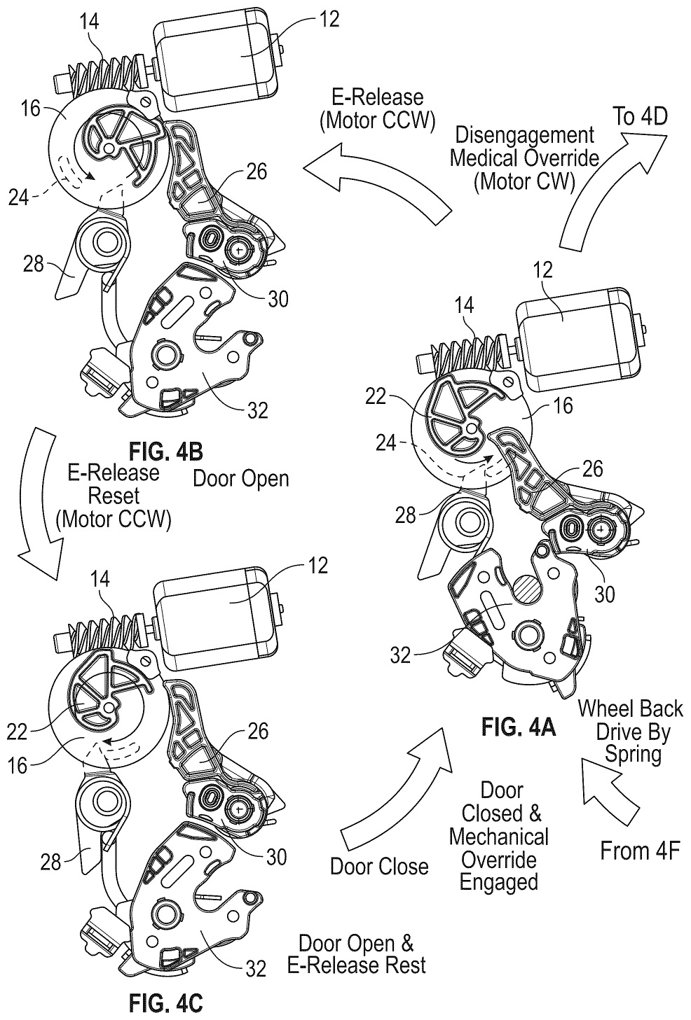

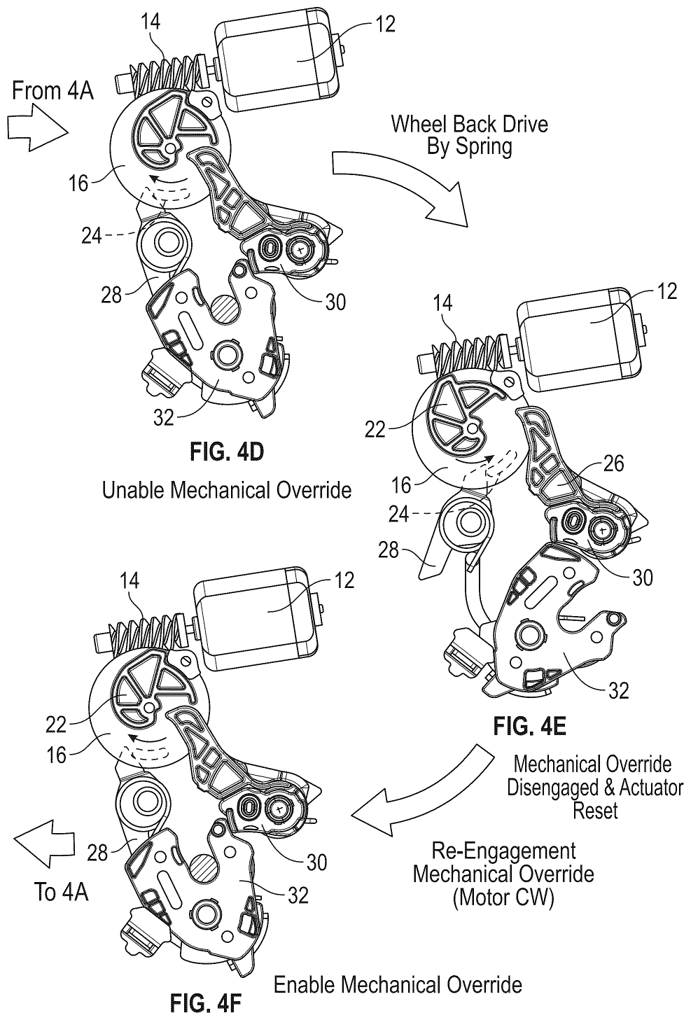

This movement is illustrated in at least FIGS. 4A-4C wherein an electric or e-release of the latch 10 is performed. During e-release, the single motor 12 with worm 14 and wheel 16 are rotated counter clock wise with respect to the views illustrated in at least FIGS. 4D-4F. FIGS. 4A-4F illustrate power release reset and engagement/disengagement of the mechanical release link.

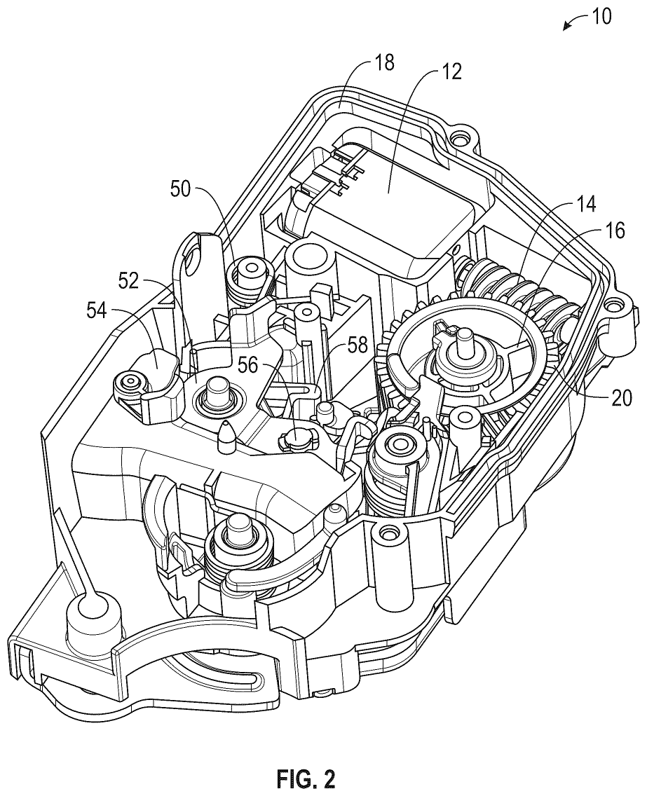

Also shown in at least FIGS. 1 and 2 are an emergency release lever 34, a lock link lever 36, a back plate 38, a block link 40, a back drive spring 42, a block lever 44, a lock lever spring 46, a lock lever 48, an interim release lever spring 50, an interim release lever 52, a pawl switch lever 54, a release link 56, and a release lever 58.

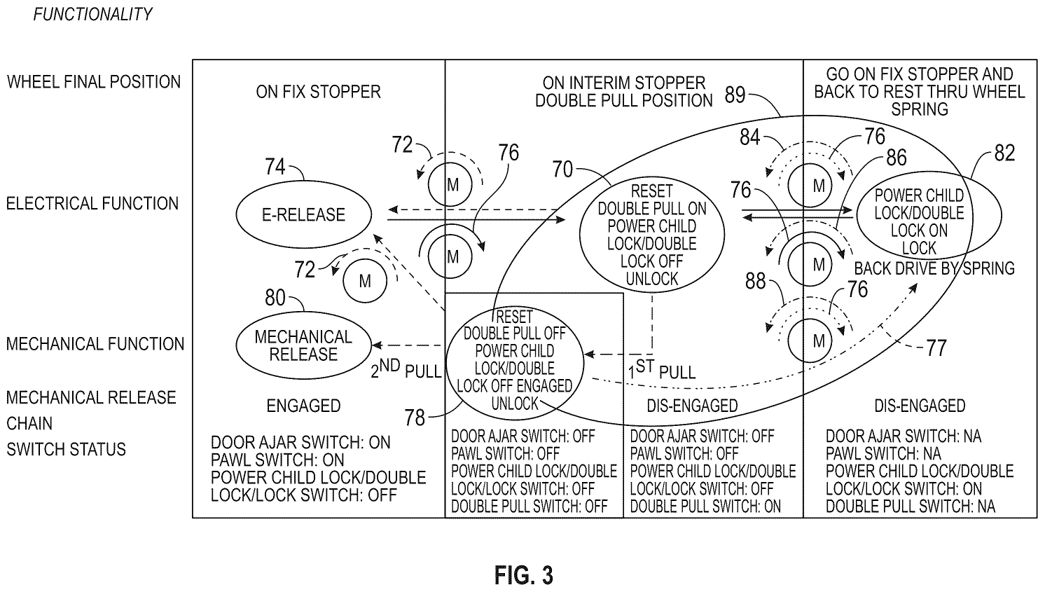

Referring now to FIG. 3 is a graphical representation of operational aspects of the vehicle latch in accordance with an embodiment of the present disclosure. When the latch 10 is reset and in a home position as illustrated by area 70 a power child lock and double lock feature is off and a double pull feature is on. This may also be referred to as an unlock position of the latch 10. From this position, the latch 10 may be e-released through movement of the single motor 12 in a first direction (counter clockwise as illustrated in FIG. 3) illustrated by arrow 72. E-release of the latch 10 is illustrated by area 74. Thereafter and in order to return the latch 10 to the position corresponding area 70, the single motor 12 is rotated in a second direction which is opposite (clockwise as illustrated in FIG. 3) to the first direction. The second direction is represented by arrow 76.

In another operation from the position illustrated by area 70, a release lever of the latch 10 is pulled for a first time and the latch 10 is in a position where the double pull function is off and the power child lock and the double lock functions are off. This position is illustrated by area 78. From this position, the latch 10 may be e-released via movement of the motor 12 in the first direction (arrow 72) resulting in the latch 10 being in the position illustrated in area 74 or alternatively the latch 10 may be mechanically released via a second pull of the release lever such that the latch is in the position illustrated by area 80. The latch 10 can then be returned to the position illustrated in area 70 by closing mechanically the vehicle door.

In addition, the latch 10 may be transitioned to a position where the Power Child Lock and/or the Double Lock are ON and the latch 10 is locked. This may also be referred to a locked latch 10. This position is illustrated by area 82. Referring back now to the position illustrated by area 70, the latch 10 may be transitioned into the position defined by area 82 by moving the single motor 12 with the worm gear 14 in the second direction 76 (clockwise as illustrated in FIG. 3) which driving the wheel 16 which moves the lock lever 48, engaging the lock link lever in the lock position, inhibiting the mechanical opening of the latch. And then the wheel 16 is back to a reset position driven by a spring illustrated by arrow 84. Arrow 84 illustrates the back driven movement of the wheel 16 by the spring. After this movement and in order to move the latch 10 back to the position designated by area 70, the single motor 12 with the worm gear 14 is once again rotated in the second direction 76 (clockwise as illustrated in FIG. 3) which drives the wheel 16 which moves the locking lever 48, disengaging the locking link lever, making the mechanical opening of the latch operational. As before, the return of wheel 16 in the reset position is achieved by a spring. This is illustrated by arrow 86 (counter clockwise as illustrated in FIG. 3).

In addition and when the latch 10 is in the position illustrated by area 78 to back to the position illustrated by the area 70, the latch 10 may transition from the position denoted by area 78 to the position denoted by area 82 by moving the single motor 12 with the worm gear 14 in the second direction 76 (clockwise as illustrated in FIG. 3) which drives the wheel 16 which moves the lock lever 48, engaging the lock link lever in the lock position, inhibiting the mechanical opening of the latch. This movement is illustrated by arrow 77. And then the wheel 16 is back to reset position driven in the by a spring. This is illustrated by arrow 88. After this movement and in order to move the latch 10 back to the position designated by area 70, the single motor 12 with the worm gear 14 is once again rotated in the second direction 76 which drives the wheel 16 which moves the locking lever 48, disengaging the locking link lever, making the mechanical opening of the latch operational. As before, the return of wheel 16 in the reset position is achieved by spring. This is illustrated by arrow 86. This operation is at least illustrated by area 89.

As used herein, double pull release is the definition of the interior release of a door latch in the locked state in 2 actions on the door handle or other interior release control. The first action on the interior door handle or other interior release control unlocks the door latch, the second action on the door handle or other interior release control opens the door latch releasing the door.

As used herein, Power Child Lock is an additional locking device that rear side door latch shall be equipped which, when engaged, prevents operation of the interior door handle, or other interior latch release control and required separate actions to unlock the door and operate the interior door handle or other interior latch release control.

As used herein, Double Lock an additional locking device for side door latch which, when engaged, prevents operation of the interior door handle, or other interior latch release control. The additional locking device can be engaged only when main locking device is engaged.

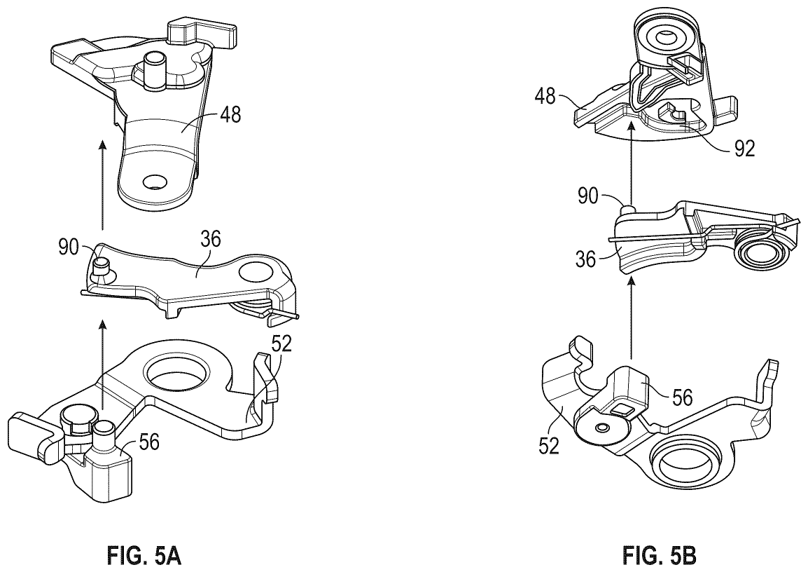

Referring now to FIGS. 5A and 5B, the lock lever 48, the lock link lever 36, the interim release lever 52, and the release link 56 are illustrated. The release link 56 is pivotally mounted to the interim release lever 52. The lock link lever 36 has a lock link lever pin 90 that protrudes upwardly from a surface of the lock link lever 36. The lock link lever pin 90 is configured to transition through a heart cam 92 of the lock lever 48.

FIGS. 5A and 5B are exploded views of components of the vehicle latch in accordance with an embodiment of the present disclosure.

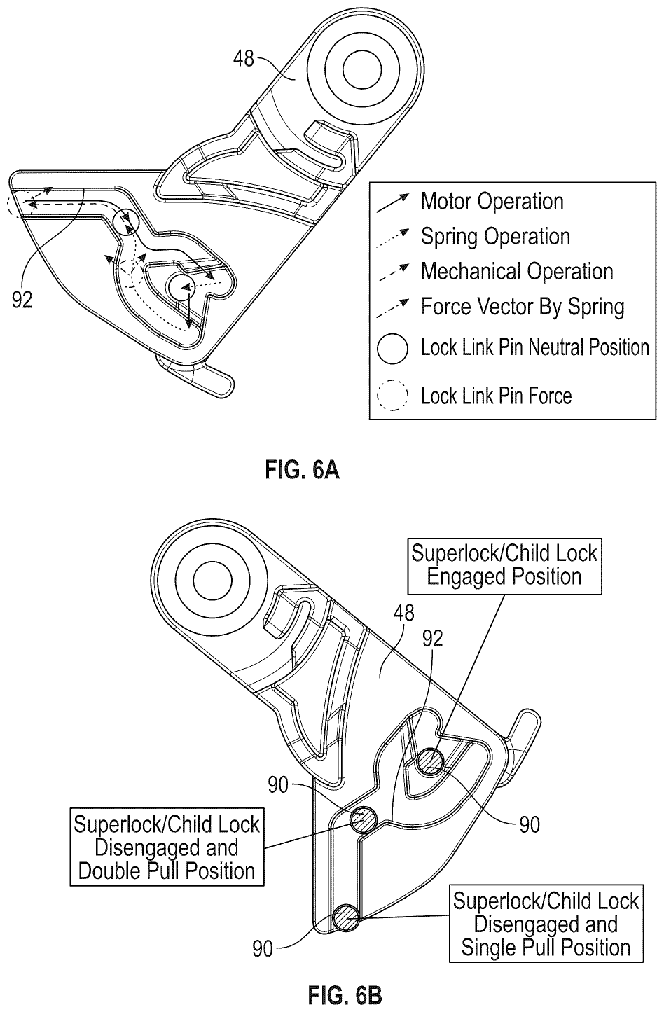

FIGS. 6A and 6B illustrate movement of the lock pin of the vehicle latch within a cam feature of the lock lever. The lock link lever pin is derived by the heart cam feature and the lock lever spring realize the engagement/disengagement of the mechanical release kinematic. The arrows in FIG. 6A illustrate “motor operation”, “spring operation”, “mechanical operation” and “force vectors by spring”. Also illustrated by the circles are a lock pin neutral position a lock link pin force.

In FIG. 6B, a Superlock/Child lock disengaged and Double pull position, a Superlock/Child lock engaged position, and a Superlock/Child lock disengaged and Single pull position are illustrated.

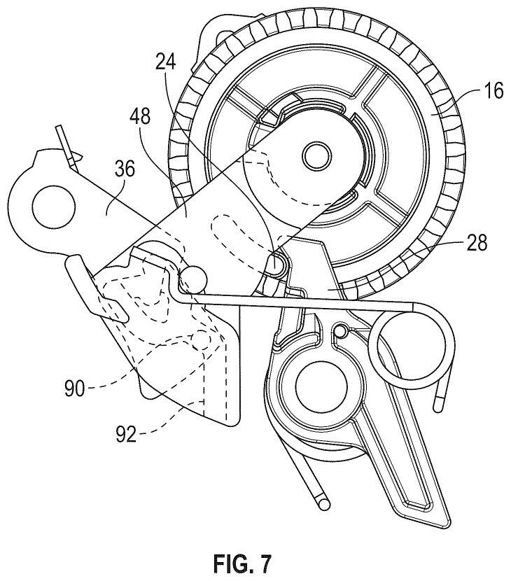

FIG. 7 illustrates portions of the vehicle latch in a door closed position wherein the latch is operational for double pull or single pull operations. FIG. 7 illustrates a engagement/disengagement of the mechanical link. FIG. 7 illustrates a Door Closed Normal Condition where Mechanical release back up is operational for double pull or single pull actions and the Lock Link Lever pin is engaged in lock lever.

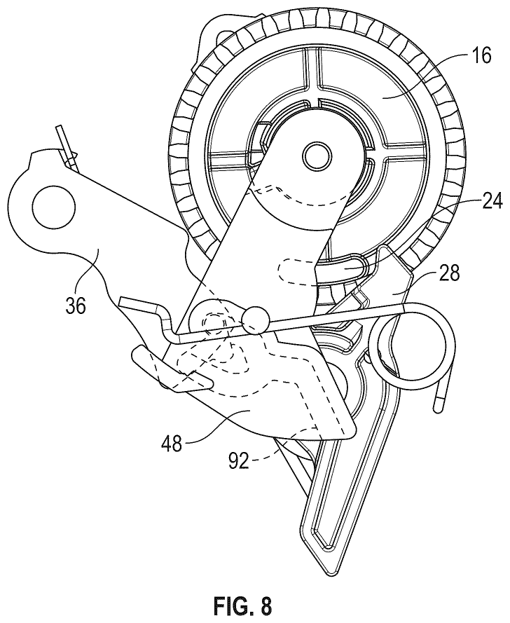

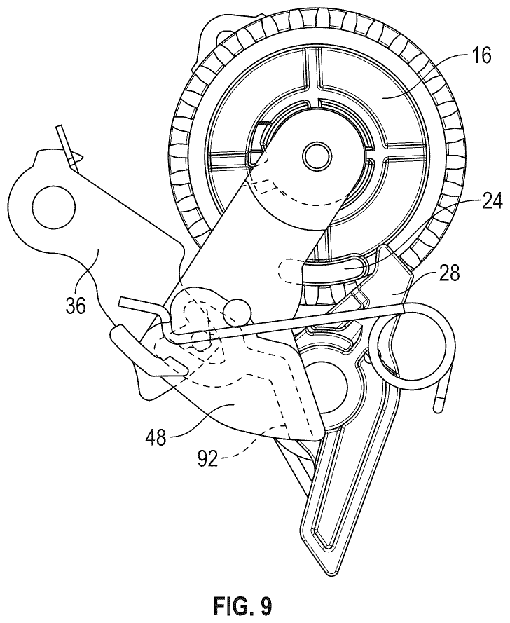

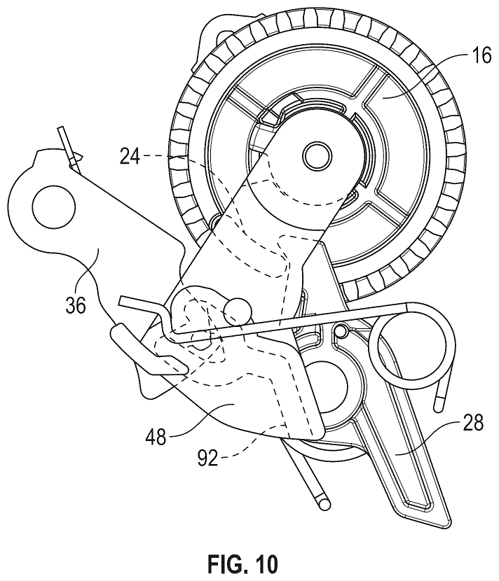

FIGS. 8-10 illustrate portions of the vehicle latch in a door closed position wherein the latch is not operational for double pull or single pull operations. FIG. 8 illustrates disengagement of the mechanical link and a Door Closed Normal Condition, Wheel in turning Counterclockwise to disengage the mechanical link and Lock Link Lever pin engage in the lock lever groove. FIG. 9 illustrates disengagement of the mechanical link and a Door Closed Normal Condition, Mechanical release back up disengaged and Lock Link Lever pin blocked in lock lever. FIG. 10 illustrates disengagement of the mechanical link and a Door Closed Normal Condition, Mechanical release back up disengaged and Lock Link Lever pin blocked in lock lever and Wheel return to rest position by the back drive spring.

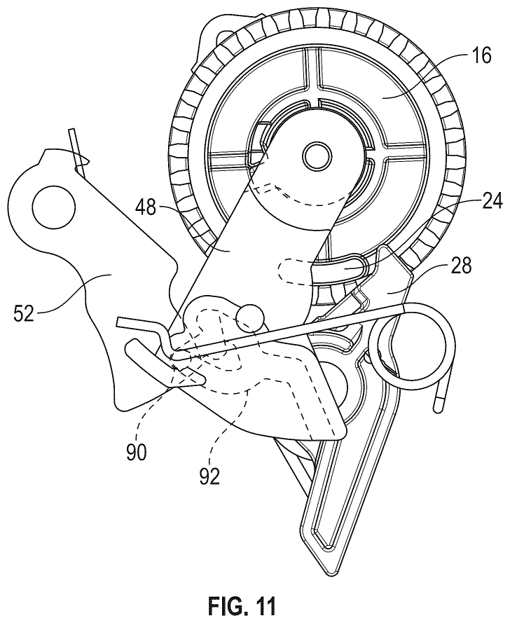

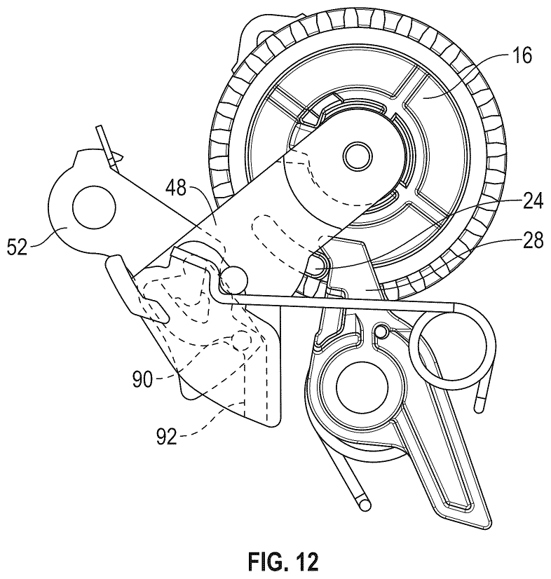

FIGS. 11-12 illustrate portions of the vehicle latch in a door closed position wherein the latch is operational for double pull or single pull operations. FIG. 11 illustrates Re-engagement of the mechanical link and Door Closed Normal Condition, Wheel in turning Counterclockwise to disengage the mechanical link and Lock Link Lever pin engage in the lock lever groove. FIG. 12 illustrates Re-engagement of the mechanical link and Door Closed Normal Condition, Mechanical release back up re-engaged—ready for mechanical release, and Lock Link Lever pin engaged in lock lever.

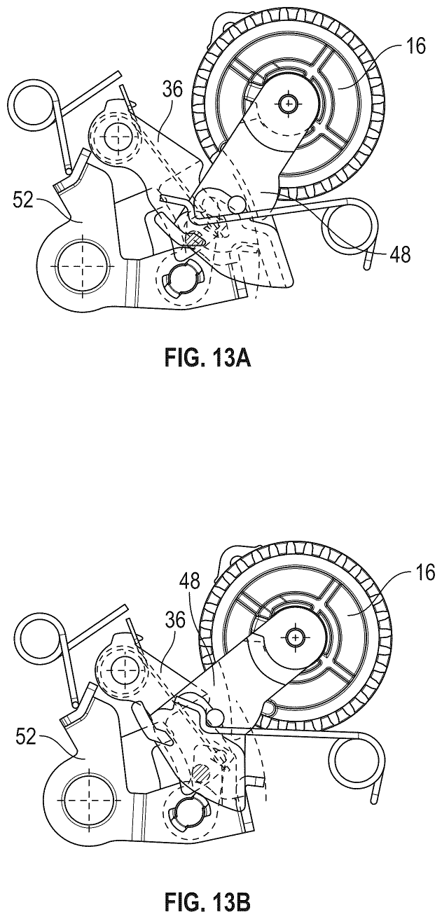

FIG. 13A illustrate portions of the vehicle latch wherein the latch is not operational for double pull or single pull operations. FIG. 13A illustrates unable mechanical override.

FIG. 13B illustrate portions of the vehicle latch wherein the latch is operational for double pull or single pull operations. FIG. 13B illustrates enable mechanical override.

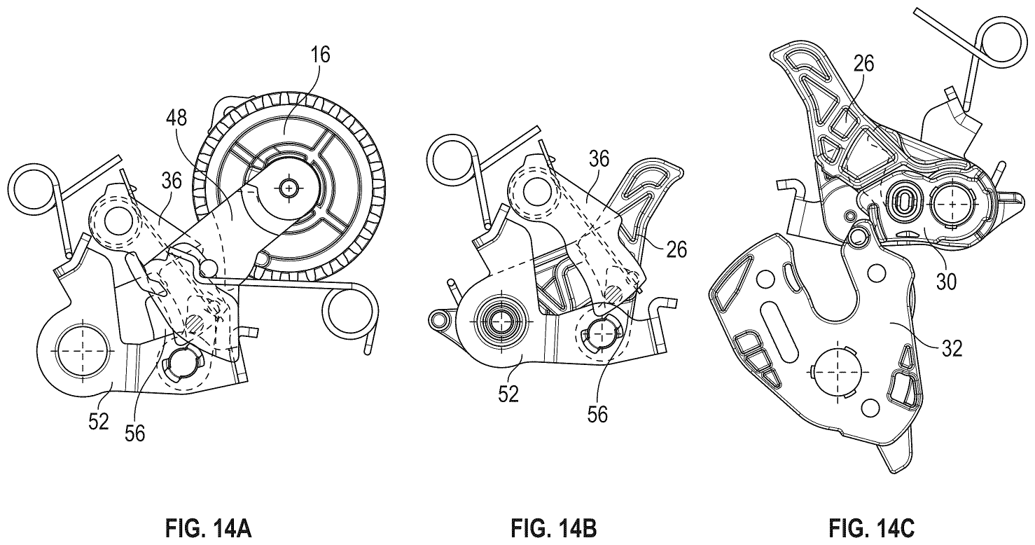

FIGS. 14A-14C illustrate portions of the vehicle latch in a door closed position wherein the latch is operational for double pull or single pull operations. FIGS. 14A-14C illustrate Mechanical release—double pull function, Door Closed Normal Condition, Mechanical release back up operational for double pull actions on handle.

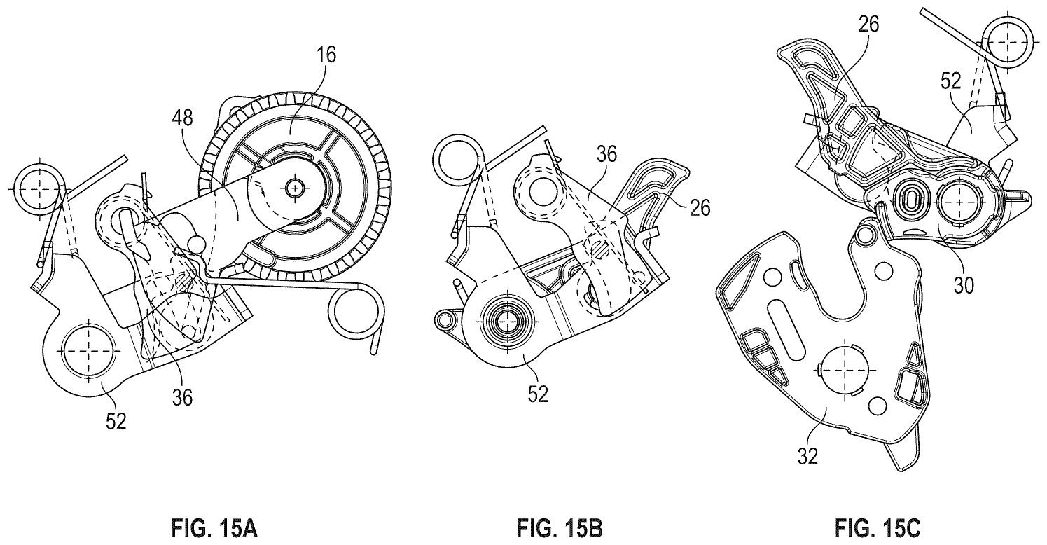

FIGS. 15A-15C illustrate portions of the vehicle latch in a door closed position during a first pull on a handle operatively coupled to the vehicle latch when the latch is operational for mechanical release. FIGS. 15A-15C illustrate Mechanical release—First pull on handle, Door Closed Normal Condition, First pull on the mechanical release back up.

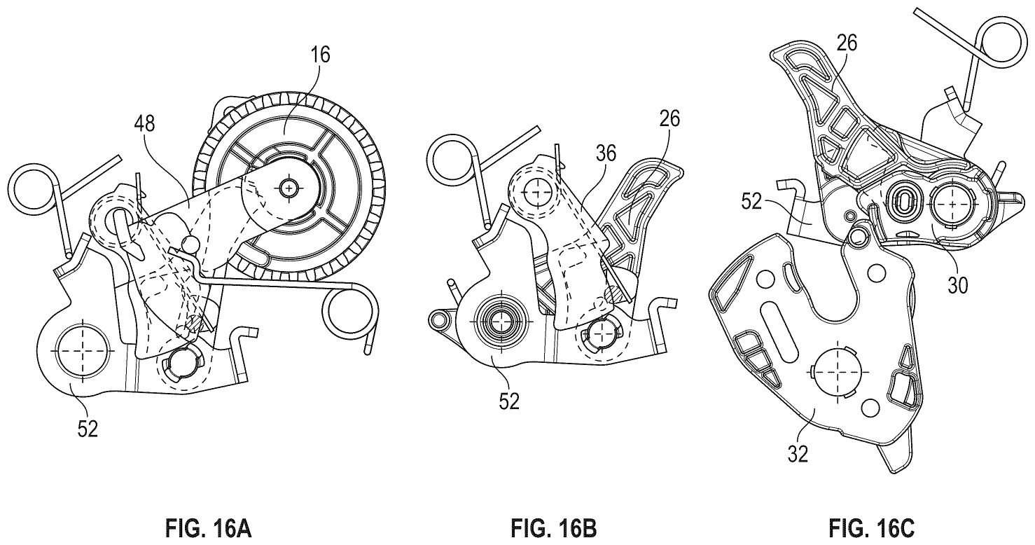

FIGS. 16A-16C illustrate portions of the vehicle latch in a door closed position after a first pull on a handle operatively coupled to the vehicle latch when the latch is operational for mechanical release. FIGS. 16A-16C illustrate Mechanical release—Return handle after first pull, Door Closed Normal Condition and Return handle and Lock Lever stay Engage position.

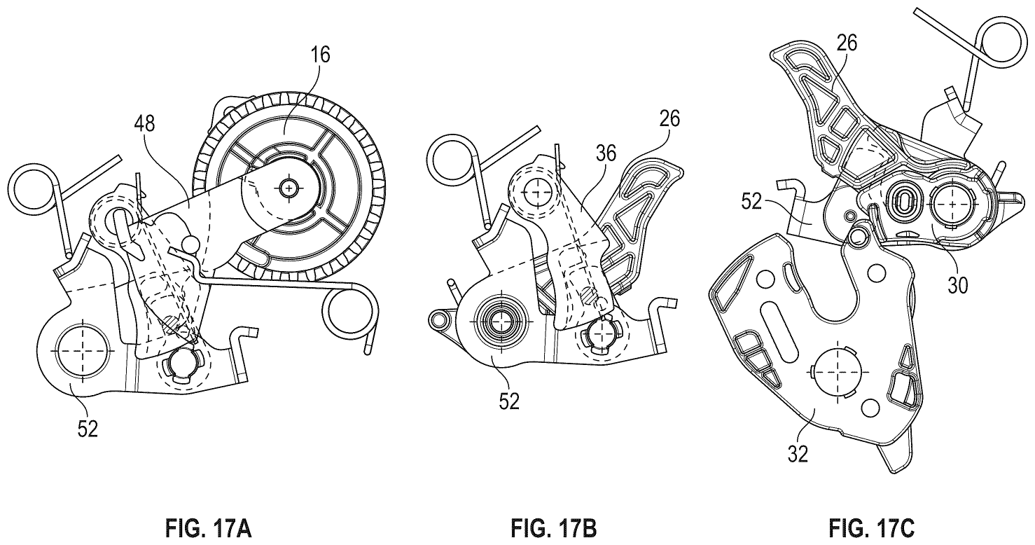

FIGS. 17A-17C illustrate portions of the vehicle latch in a door closed position after a first pull on a handle operatively coupled to the vehicle latch when the latch is operational for mechanical release. FIGS. 17A-17C illustrate Mechanical release—Return handle after first pull, Door Closed Normal Condition and Release link engaged in release lever.

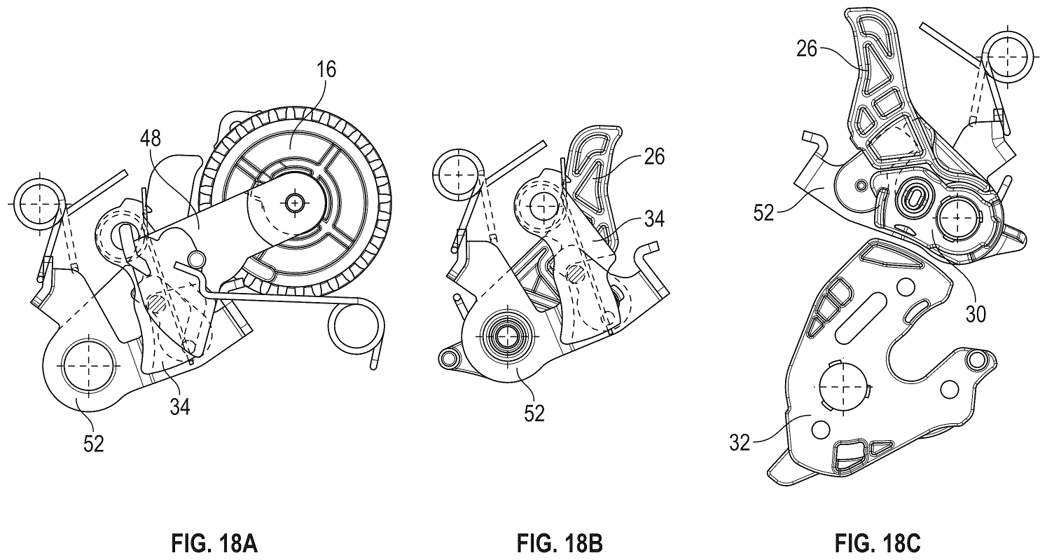

FIGS. 18A-18C illustrate portions of the vehicle latch in a door closed position during a second pull on a handle operatively coupled to the vehicle latch when the latch is operational for mechanical release. FIGS. 18A-18C illustrate Mechanical release—2^{nd} pull on handle, Door release.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A vehicle latch (10), comprising:
only a single motor (12) for driving a worm (14) operably coupled to the single motor (12), the worm (14) meshingly engages a wheel (16) rotatably mounted to a housing (18) of the latch (10);
during an electric release of the latch (10) the single motor (12) rotates the wheel (16) from a reset position in a first direction (72), thereafter and to return the wheel (16) to the reset position the single motor (12) rotates the wheel (16) in a second direction (76), which is opposite to the first direction (72); and
rotation of the of the wheel (16) by the single motor (12) from the reset position in the second direction (76) will position the latch (10) into a Power Child Lock and/or a Double Lock position, thereafter the wheel (16) is rotated back into the reset position by a spring, rotation of the wheel (16) by the single motor (12) from the reset position in the second direction (76) a second time will disengage the latch (10) from the Power Child Lock and/or the Double Lock position, making mechanical opening of the latch (10) operational, thereafter the wheel (16) is rotated back into the reset position by a spring.

2. The vehicle latch (10) as in claim 1, wherein the worm (14) meshingly engages a plurality of teeth (20) located about a periphery of the wheel (16).

3. The vehicle latch (10) as in claim 1, wherein the wheel (16) also has a cam portion (22) located on one side of the wheel (16) and a driving feature (24) located on an opposite side of the wheel (16).

4. The vehicle latch (10) as in claim 3, wherein the cam portion (22) is configured for engaging a release lever (26) while the driving feature (24) is configured to engage a block lever (28).

5. The vehicle latch (10) as in claim 4, wherein the release lever (26) and the block lever (28) are rotatably mounted to the latch (10).

6. The vehicle latch (10) as in claim 5, wherein the release lever (26) is operably coupled a pawl (30) such that movement of the release lever (26) by the cam portion (22) of the wheel (16) will cause movement of the pawl (30), the pawl (30) being configured to engage a claw (32) of the latch (10) in order to maintain the claw (32) in a closed or secondary position or primary position and wherein movement of the pawl (30) from an engaged position to a disengaged position will allow the claw (32) to pivot or rotate into an open position.

7. The vehicle latch (10) as in claim 6, wherein when the vehicle latch (10) is reset and in a home position a power child lock feature and a double lock feature are off and a double pull feature is on, from this position, the latch (10) may be e-released through movement of the single motor (12) in a first direction, thereafter and in order to return the latch (10) the home position, the single motor (12) is rotated in a second direction which is opposite to the first direction.

8. The vehicle latch (10) as in claim 7, further comprising:
a lock link lever (36); and
a lock lever (48), wherein the lock link lever (36) has a lock lever pin (90) that protrudes upwardly from a surface of the lock link lever (36), the lock link lever pin (90) being configured to transition through a cam (92) of the lock lever (48).

9. The vehicle latch (10) as in claim 7, further comprising:
an emergency release lever (34);
a lock link lever (36);
a back plate (38)
a block link (40);
a back drive spring (42);
a block lever (44);
a lock lever spring (46);
a lock lever (48);
an interim release lever spring (50); an interim release lever (52);
a pawl switch lever (54);
a release link (56); and
a release lever (58).

10. The vehicle latch (10) as in claim 9, wherein the lock link lever (36) has a lock lever pin (90) that protrudes upwardly from a surface of the lock link lever (36), the lock link lever pin (90) being configured to transition through a cam (92) of the lock lever (48).

11. The vehicle latch (10) as in claim 10, wherein the worm (14) meshingly engages a plurality of teeth (20) located about a periphery of the wheel (16).

12. A method of opening a vehicle latch (10) with only a single motor (12), comprising:
operably coupling the only a single motor (12) for driving a worm (14) operably coupled to the single motor (12), the worm (14) meshingly engages a wheel (16) rotatably mounted to a housing (18) of the latch (10);
electrically releasing the latch (10) with the single motor (12) by rotating the wheel (16) from a reset position in a first direction (72), thereafter returning the wheel (16) to the reset position by rotating the single motor (12) in a second direction (76), which is opposite to the first direction (72);
placing the latch (10) into a Power Child Lock and/or a Double Lock position by rotating the wheel (16) by the single motor (12) from the reset position in the second direction (76), thereafter the wheel (16) is rotated back into the reset position by a spring; and
disengaging the latch (10) from the Power Child Lock and/or the Double Lock position, by rotating the wheel (16) by the single motor (12) from the reset position in the second direction (76) a second time, thereby making mechanical opening of the latch (10) operational, thereafter the wheel (16) is rotated back into the reset position by a spring.

13. The method as in claim 12, wherein the wheel (16) also has a cam portion (22) located on one side of the wheel (16) and a driving feature (24) located on an opposite side of the wheel (16).

14. The method as in claim 13, wherein the cam portion (22) is configured for engaging a release lever (26) while the driving feature (24) is configured to engage a block lever (28).

15. The method as in claim 14, wherein the vehicle latch (10) includes: a lock link lever (36); and a lock lever (48), wherein the lock link lever (36) has a lock lever pin (90) that protrudes upwardly from a surface of the lock link lever (36), the lock link lever pin (90) being configured to transition through a cam (92) of the lock lever (48).
